(19) United States
(12) Patent Application Publication
(10) Pub. No.: US 2019/0072962 A1
(43) Pub. Date: Mar. 7, 2019

(54) DRONE FOR COLLECTING AND PROVIDING IMAGE MATERIAL FOR BOMB DAMAGE ASSESSMENT AND AIR-TO-GROUND ARMAMENT SYSTEM HAVING SAME

(71) Applicant: EXENS Co., LTD., Seoul (KR)

(72) Inventor: Bo Hyun SHIN, Seoul (KR)

(73) Assignee: EXENS Co.,LTD., Seoul (KR)

(21) Appl. No.: 16/082,726

(22) PCT Filed: Feb. 14, 2017
(86) PCT No.: PCT/KR2017/001593

§ 371 Date: Sep. 6, 2018

(30) Foreign Application Priority Data
Mar. 8, 2016 (KR) 10-2016-0027691

(51) Int. Cl. G05D 1/00; B64D 47/08; G08G 5/00; B64C 39/02

(52) U.S. Cl. CPC G05D 1/0094; B64D 47/08; G08G 5/0069; B64C 39/024; B64C 2201/146; B64C 2201/082; B64C 2201/102; B64C 2201/127; B64C 2201/121

(57) ABSTRACT

The present invention relates to a drone for collecting and providing image data for bomb damage assessment and an air-to-ground weapon system equipped with the drone. The air-to-ground weapon system includes: a hitting means moving to a bombardment target to hit the bombardment target; and a drone detachably attached to the hitting means.

### TECHNICAL FIELD

The present invention relates to a drone for collecting and providing image data for bomb damage assessment and an air-to-ground weapon system equipped with the same.

### BACKGROUND ART

Bomb damage assessment (BDA), which has been conducted in the past, is performed by a method in which a fighter, an attacker, a bomber or the like drops weapons on ground targets, and then reads images in a ground target region captured by a tactical reconnaissance aircraft sent as subsequent military power to determine damage levels thereof.

However, the BDA method is based on the damage of the sent tactical reconnaissance aircraft.

Meanwhile, in recent years, with the development of science and technology, military power has been developed as an operational concept to weaken the warfare will of the enemy with the minimum sacrifice, and the development of long-range precision air-to-ground guided weapons to minimize the damage to attack power on the ground targets has been generalized.

Therefore, the conventional BDA method does not consider the minimization of the military power damage of the tactical reconnaissance aircraft or the like, and therefore does not meet the development trend of the military power.

However, the BDA needs to be performed in any form as a mandatory requirement for continuous military power operation, and there is a desperate need to effectively perform the BDA without damage to possible tactical reconnaissance aircraft.

On the other hand, the technology as a background of the present invention is disclosed in Korean Patent Publication No. 10-1996-0038343.

### DISCLOSURE

### Technical Problem

An object of the present invention is to provide a drone for collecting and providing image data for bomb damage assessment (BDA) and an air-to-ground weapon system equipped with the same capable of performing the BDA while minimizing damage to military power.

### Technical Solution

An aspect of the present invention provides an air-to-ground weapon system including a hitting means moving to a bombardment target to hit the bombardment target; and a drone detachably attached to the hitting means.

The drone may acquire images of the bombardment target separated from the hitting means and hit by the hitting means when the hitting means reaches a position set from the bombardment target to transmit the acquired images to the outside.

The drone may be attached to the hitting means in a state where the wings are folded and the drone may be separated from the hitting means and then unfolded when the hitting means reaches a position set from the bombardment target.

The air-to-ground weapon system may further include a cartridge connecting the hitting means and the drone, in which the cartridge may be exploded to separate the drone from the hitting means when the hitting means reaches a position set from the bombardment target.

The drone may include a streamlined body, a capturing unit disposed on a front side of the body to capture the bombardment target, wings coupled to the body so as to be folded, a GPS module installed in the body, and a controller connected to the GPS module and the cartridge, in which the controller may explode the cartridge based on a signal received to the GPS module when the hitting means reaches a position set from the bombardment target.

The cartridge may include a separation portion separated by explosion, a first bonding portion formed at one end of the separation portion to be attached to the hitting means, and a second bonding portion formed at the other end of the separation portion to be attached to the drone.

The separation portion may be exploded so that the drone is separated from the hitting means in a moving direction and an inclined direction of the hitting means.

Another aspect of the present invention provides a drone for collecting and providing image data including: a cartridge moving to a bombardment target to be attached to a hitting means hitting the bombardment target; a body attached to the cartridge; a capturing unit disposed at a front side of the body and capturing the bombardment target hit by the hitting unit to transmit the captured bombardment target to the outside; wings coupled to the body so as to be folded; a GPS module installed in the body; and a controller connected to the GPS module and the cartridge, in which the controller explodes the cartridge based on a signal received to the GPS module when the hitting means reaches a position set from the bombardment target.

The drone for collecting and providing image data may further include a self-bombing unit installed in the body, in which the self-bombing unit may be exploded when the capturing unit captures the bombardment target hit by the hitting means and transmits the captured image to the outside.

The self-bombing unit may be exploded by an external signal.

### Advantageous Effects

According to the drone for collecting and providing image data for bomb damage assessment (BDA) and the air-to-ground weapon system equipped with the same of the present invention, it is possible to acquire image information for BDA of a bombardment target while hitting the bombardment target in real time and provide the acquired image information to the outside.

The drone for collecting and providing image data for the BDA of the present invention is separated from the hitting means before the hitting means hits the bombardment target to reach a point spaced apart from the bombardment target at a predetermined distance.

### DESCRIPTION OF DRAWINGS

FIG. 1 is a view for describing an air-to-ground weapon system according to an exemplary embodiment of the present invention.

FIG. 2 is a view for describing an operation of the air-to-ground weapon system of FIG. 1.

FIG. 3 is a view for describing a coupling portion of a drone for collecting and providing image data with a hitting means in the air-to-ground weapon system of FIG. 1.

FIG. 4 is a partial configuration view of the drone for collecting and providing image data of the air-to-ground weapon system of FIG. 1.

FIG. 5 is a view for describing a process in which the drone for collecting and providing image data is restored to its original shape in the air-to-ground weapon system of FIG. 1.

FIGS. 6 and 7 are views for describing a cartridge of the drone for collecting and providing image data of FIG. 3.

FIG. 8 is a flowchart of a method of bombing and capturing a bombardment target according to another exemplary embodiment of the present invention.

### MODES OF THE INVENTION

Hereinafter, a drone for collecting and providing image data and an air-to-ground weapon system equipped with the same will be described with reference to the accompanying drawings.

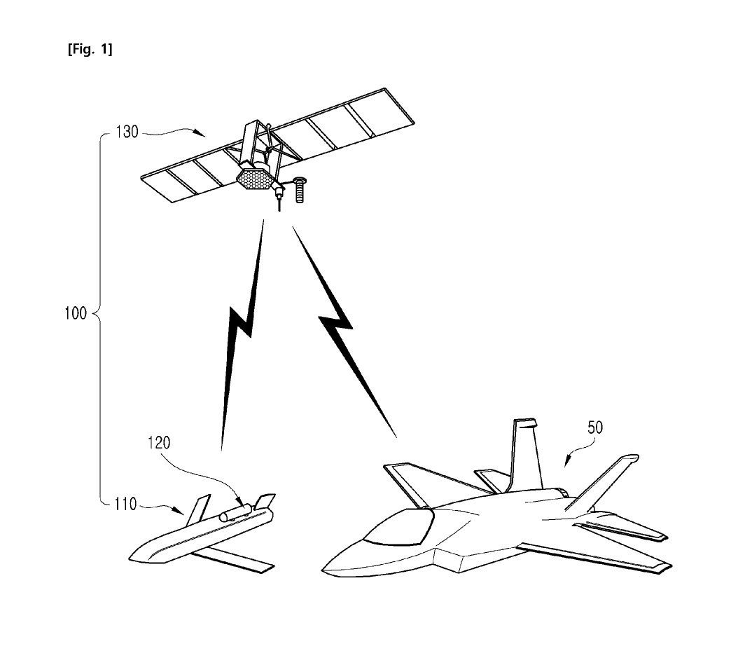

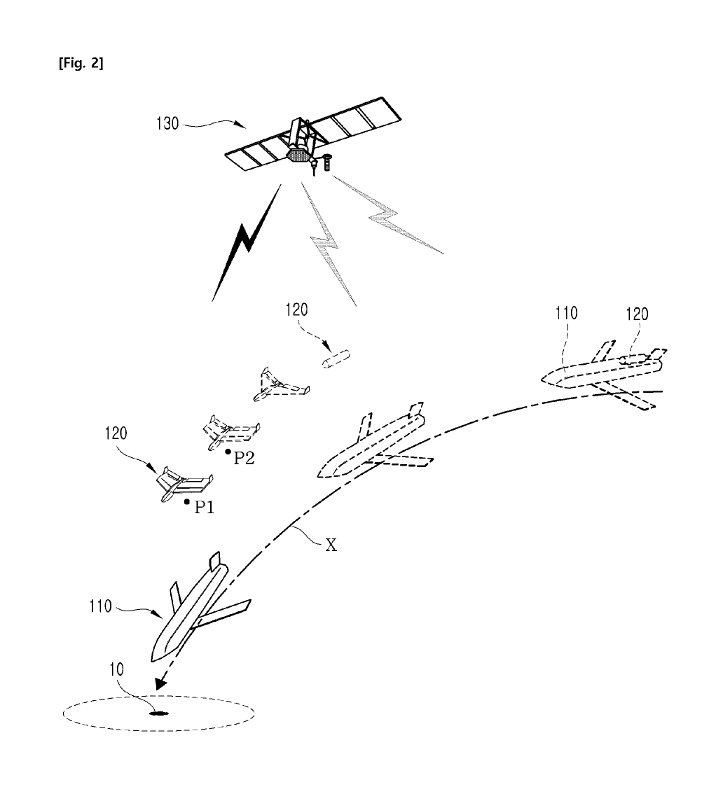

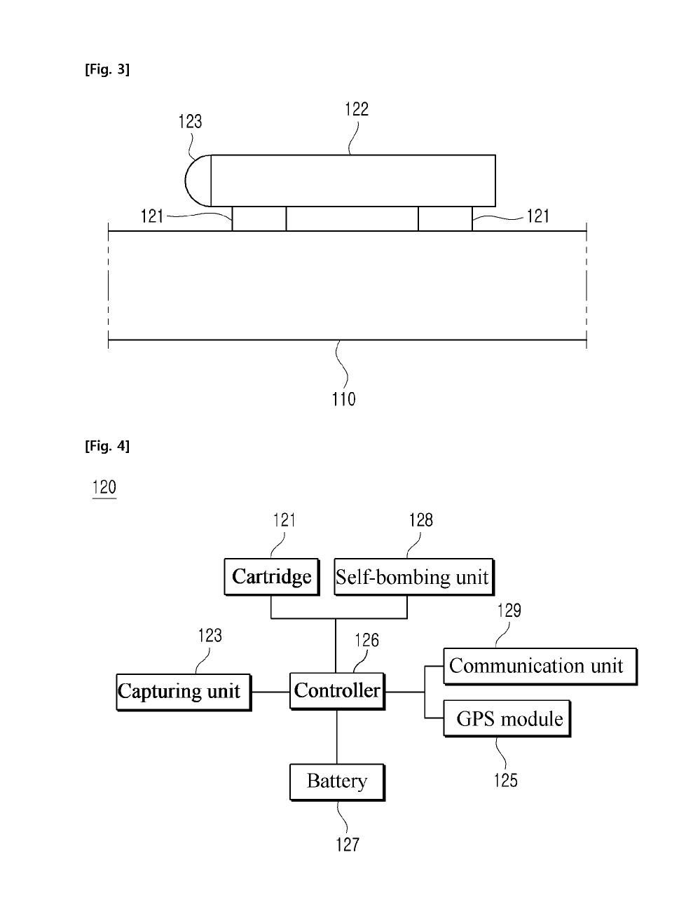

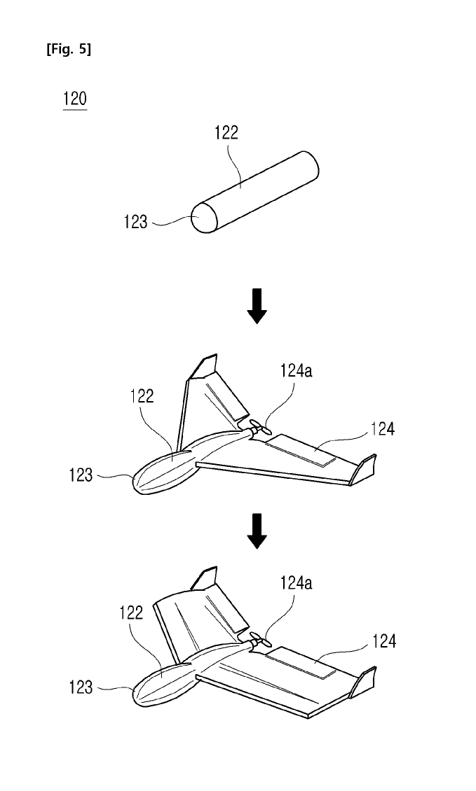

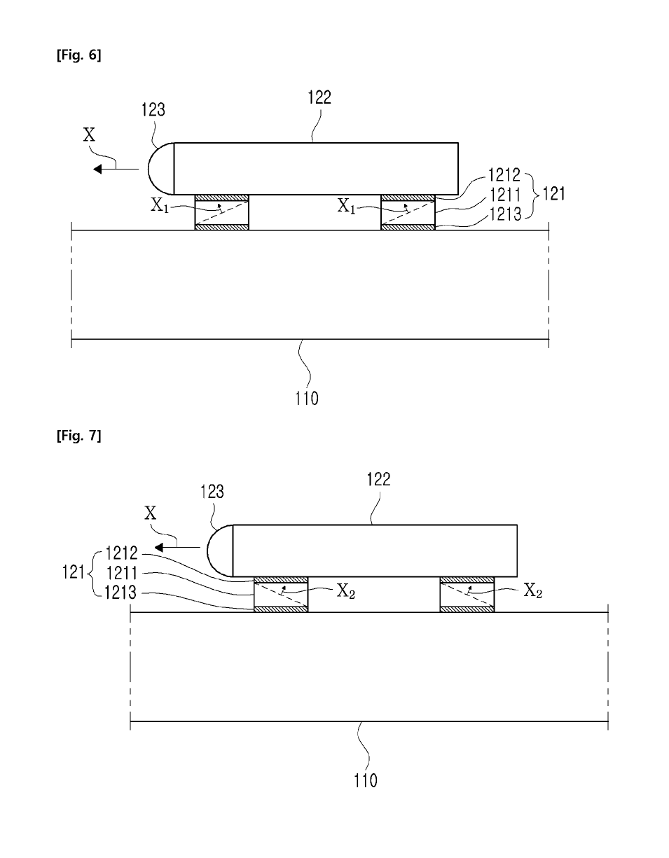

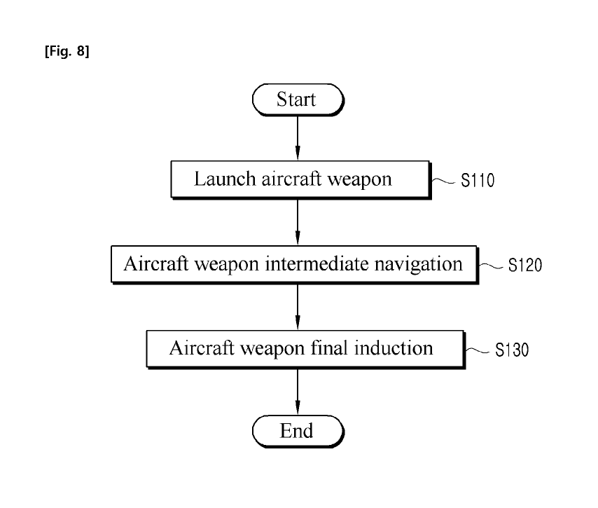

FIG. 1 is a view for describing an air-to-ground weapon system according to an exemplary embodiment of the present invention, FIG. 2 is a view for describing an operation of the air-to-ground weapon system of FIG. 1, FIG. 3 is a view for describing a coupling portion of a drone for collecting and providing image data with a hitting means in the air-to-ground weapon system of FIG. 1, FIG. 4 is a partial configuration view of the drone for collecting and providing image data in the air-to-ground weapon system of FIG. 1, FIG. 5 is a view for describing a process in which the drone for collecting and providing image data is restored to its original shape in the air-to-ground weapon system of FIG. 1, FIGS. 6 and 7 are views for describing a cartridge of the drone for collecting and providing image data of FIG. 3, and FIG. 8 is a flowchart of a method of bombing and capturing a bombardment target according to another exemplary embodiment of the present invention.

Referring to FIGS. 1 to 3, an air-to-ground weapon system 100 of the present invention may include a hitting means 110 and a drone 120 (hereinafter, referred to as a “drone for collecting and providing image data”).

The hitting means 110 may hit a bombardment target 10. The bombardment target 10 means a target to be attacked.

The drone 120 of collecting and providing image data means an unmanned aerial vehicle (UAV) flying through automatic or remote controlling and may transmit images (hereinafter, “image information”) obtained by capturing the bombardment target 10 hit by the hitting means 110.

That is, the air-to-ground weapon system 100 may hit the bombardment target 10 by the hitting means 110, collect the image information using the drone 120 of collecting and providing the image data in real time, and transmit the collected image information to the outside.

In addition, the drone 120 of collecting and providing the image data has wings having a size capable of generating lift force corresponding to the self weight of the drone 120 of collecting and providing the image data at a forward speed of 20 m/s when the drone 120 is restored in a circular shape.

The air-to-ground weapon system 100 may further include a communication repeater 130.

The communication repeater 130 means a device capable of wireless communication such as a satellite or a mobile repeater, and may receive the image information from the drone 120 of collecting and providing the image data. The image information may be used for bomb damage assessment (BDA).

The hitting means 110 refers to all aircraft weapons that move to the bombardment target 10 from a fighter 50, an attacker, a bomber, or the like to hit the bombardment target 10. For example, the hitting means 110 may be an air-to-ground bomb.

The drone 120 of collecting and providing the image data is detachably attached to the hitting means 110.

To this end, the drone 120 of collecting and providing the image data may include a cartridge 121.

The cartridge 121 connects the hitting means 110 and the drone 120 of collecting and providing the image data.

In addition, when the hitting means 110 reaches a position set from the bombardment target 10, the cartridge 121 is exploded to separate the drone 120 of collecting and providing the image data from the hitting means 110.

Here, the position set from the bombardment target 10 means a random point far away from the bombardment target 10.

The position set from the bombardment target 10 may be determined according to a speed of the hitting means 110, a bombardment scale, a temperature, humidity, and the like.

The drone 120 of collecting and providing the image data may be detachably attached to a rear side of the hitting means 110 in order to minimize an effect on flight performance of the hitting means 110.

The drone 120 of collecting and providing the image data is attached to the hitting means 110 in a state where the wings are folded, and may be operated after the wings are unfolded after being separated from the hitting means 110 when the hitting means 110 reaches the position set from the bombardment target 10.

The operated drone 120 of collecting and providing the image data may acquire an image of the bombardment target 10 hit by the hitting means 110 and transmit the acquired image to the outside.

Referring further to FIGS. 4 and 5, the drone 120 of collecting and providing the image data may further include a body 122, a capturing unit 123, wings 124, a GPS module 125, a controller 126, and a battery 127.

The body 122 may have a streamlined shape. The capturing unit 123, the wings 124, the GPS module 125, the controller 126, and the battery 127 may be installed in the body 122.

The capturing unit 123 may be disposed on the front side of the body 122 to capture the bombardment target 10 and transmit the captured bombardment target 10 to the outside.

The wings 124 are coupled to the body 122 to be folded. When the wings 124 are folded on the body 122, the drone 120 of collecting and providing the image data has an entirely cylindrical shape, and the front end of the drone 120 of collecting and providing the image data may have a semi-circular shape by the capturing unit 123.

The wings 124 are folded on the body 122 by a pressing force. In addition, when the drone 120 of collecting and providing the image data is spaced apart from the hitting means 110, the pressing force is released so that the wings 124 may be unfolded on the body 122.

The GPS module 125 is installed in the body 122 and may receive a current position of the drone 120 of collecting and providing the image data.

The controller 126 is connected to the GPS module 125 and the cartridge 121.

The controller 126 may bomb the cartridge 121 based on a signal received to the GPS module 125 when the hitting means 110 reaches a position set from the bombardment target 10.

Meanwhile, the cartridge 121 may include a separation portion 1211, a first boding portion 1212, and a second bonding portion 1213.

The separation portion 1211 may be exploded and separated by the controller 126.

The first bonding portion 1213 is formed at one end of the separation portion 1211 to be attached to the hitting means 110 and the second bonding portion 1212 is formed at the other end of the separation portion 1211 to be attached to the drone 120 of collecting and providing the image data.

The separation portion 1211 may be exploded so that the drone 120 of collecting and providing the image data is spaced apart from the hitting means 110 in a moving direction X and inclined directions X1 and X2 of the hitting means 110.

For example, when the separation portion 1211 is exploded to apply external force to the drone 120 of collecting and providing the image data in the moving direction X and the inclined first direction X1 of the hitting means 110, the drone 120 of collecting and providing the image data may reach a first point P1 close to the bombardment target 10 at the time when the hitting means 110 hits the bombardment target 10 (see FIG. 2).

On the other hand, when the separation portion 1211 is exploded to apply external force to the drone 120 of collecting and providing the image data in the moving direction X and the inclined second direction X2 of the hitting means 110, the drone 120 of collecting and providing the image data may reach a second point P2 far away from the bombardment target 10 at the time when the hitting means 110 hits the bombardment target 10 (see FIG. 2).

Here, a distance between the first point P1 and the bombardment target 10 is shorter than a distance between the second point P2 and the bombard target 10.

Meanwhile, the drone 120 of collecting and providing the image data may further include a self-bombing unit 128.

The self-bombing unit 128 is installed in the body 122 and exploded to damage the body 122, the capturing unit 123, the GPS module 125, the battery 127, and the like.

The self-bombing unit 128 may also be controlled to be exploded by the controller 126 when the capturing unit 123 captures the bombardment target 10 hit by the hitting unit 110 to transmit the image information to the outside.

In addition, the self-bombing unit 128 may be controlled by the controller 126 to be exploded when a capacity of the battery 127 drops below a predetermined level.

In addition, the self-bombing unit 128 may be exploded by an external signal.

In more detail, the drone 120 of collecting and providing the image data may include a communication unit 129, and the communication unit 129 is connected to the self-bombing unit 128 by the controller 126, and the controller 126 may control the self-bombing unit 128 to be exploded when the communication unit 129 receives a self-bombing signal from the outside.

Hereinafter, an operation method (hereinafter, referred to as a “method for bombing and capturing a bombardment target”) in the air-to-ground weapon system according to another exemplary embodiment of the present invention will be described with reference to FIGS. 2 to 8.

For convenience of description, an example in which the hitting means 110 of the air-to-ground weapon system 100 is the aircraft weapon installed in the fighter 50 will be described.

The method for bombing and capturing the bombardment target includes an aircraft weapon launch step (S100), an aircraft weapon intermediate navigation step (S120), and an aircraft weapon final induction step (S130).

First, in the aircraft weapon launch step (S100), the aircraft weapon may be launched from the flying fighter 50 and the like.

The fighter 50 and the like may be separated from the bombardment target 10 after launching the aircraft weapon outside a threat range of an enemy's surface-to-air weapon at several hundreds km away from the bombardment target 10.

Next, in the aircraft weapon intermediate navigation step (S120), the aircraft weapon approaches the bombardment target 10 by its own navigation. That is, the aircraft weapon approaches the bombardment target 10 using navigation data such as an inertial navigation system, a GPS, and pre-input image information.

In addition, the aircraft weapon may perform low altitude stealth cruise for stealth infiltration.

Finally, in the aircraft weapon final induction step (S130), when the aircraft weapon approaches the bombardment target 10, the aircraft weapon identifies the bombardment target 10 by an IIR seeker sensor to correct a final hitting point and then homes to the bombardment target 10.

In the aircraft weapon final induction step (S130), the drone 120 of collecting and providing the image data is separated from the aircraft weapon at a point spaced apart from the bombardment target 10 by 1 km to 2 km and the capturing unit 123 captures the bombardment target 10 hit by the aircraft weapon.

The image captured by the capturing unit 123 is transmitted to the communication repeater 130.

Although the exemplary embodiments of the present invention have been described in detail with reference to the accompanying drawings, the present invention is not limited thereto and may be embodied in many different forms without departing from the technical concept of the present invention. Therefore, the exemplary embodiments of the present invention are provided for illustrative purposes only but not intended to limit the technical concept of the present invention. The scope of the technical concept of the present invention is not limited thereto. The protective scope of the present invention should be construed based on the following claims, and all the technical concepts in the equivalent scope thereof should be construed as falling within the scope of the present invention.

1. An air-to-ground weapon system comprising:
a hitting means moving to a bombardment target to hit the bombardment target; and
a drone detachably attached to the hitting means.

2. The air-to-ground weapon system of claim 1, wherein the drone acquires images of the bombardment target separated from the hitting means and hit by the hitting means when the hitting means reaches a position set from the bombardment target to transmit the acquired images to the outside.

3. The air-to-ground weapon system of claim 2, wherein the drone is attached to the hitting means in a state where the wings are folded and the drone is separated from the hitting means and then unfolded when the hitting means reaches a position set from the bombardment target.

4. The air-to-ground weapon system of claim 2, further comprising:
a cartridge connecting the hitting means and the drone,
wherein the cartridge is exploded to separate the drone from the hitting means when the hitting means reaches a position set from the bombardment target.

5. The air-to-ground weapon system of claim 4, wherein the drone includes
a streamlined body,
a capturing unit disposed on a front side of the body to capture the bombardment target,
wings coupled to the body so as to be folded,
a GPS module installed in the body,
and a controller connected to the GPS module and the cartridge,
wherein the controller explodes the cartridge based on a signal received to the GPS module when the hitting means reaches a position set from the bombardment target.

6. The air-to-ground weapon system of claim 4, wherein the cartridge includes
a separation portion separated by explosion,
a first bonding portion formed at one end of the separation portion to be attached to the hitting means, and
a second bonding portion formed at the other end of the separation portion to be attached to the drone.

7. The air-to-ground weapon system of claim 6, wherein the separation portion is exploded so that the drone is separated from the hitting means in a moving direction and an inclined direction of the hitting means.

8. A drone for collecting and providing image data comprising:
a cartridge moving to a bombardment target to be attached to a hitting means hitting the bombardment target;
a body attached to the cartridge;
a capturing unit disposed at a front side of the body and capturing the bombardment target hit by the hitting unit to transmit the captured bombardment target to the outside;
wings coupled to the body so as to be folded;
a GPS module installed in the body; and
a controller connected to the GPS module and the cartridge,
wherein the controller explodes the cartridge based on a signal received to the GPS module when the hitting means reaches a position set from the bombardment target.

9. The drone for collecting and providing image data of claim 8, further comprising:
a self-bombing unit installed in the body,
wherein the self-bombing unit is exploded when the capturing unit captures the bombardment target hit by the hitting means and transmits the captured image to the outside.

10. The drone for collecting and providing image data of claim 9, wherein the self-bombing unit is exploded by an external signal.
